(19) United States
(12) Patent Application Publication
(10) Pub. No.: US 2007/0063554 A1
(43) Pub. Date: Mar. 22, 2007

(54) Bike seat adjustment

(75) Inventor: Hsueh-Sen Liao, Hsin-Chu Hsien (TW)

Correspondence Address: TROXELL LAW OFFICE PLLC;SUTE 1404, 5205 LEESBURG PIKE, FALLS CHURCH, VA, 22041, US

(73) Assignee: Hsin Lung Accessories Co., Ltd.

(21) Appl. No.: 11/523,524

(22) Filed: Sep. 20, 2006

(30) Foreign Application Priority Data
Sep. 22, 2005 (TW) 94216337

(51) Int. Cl. B62J 1/00

(52) U.S. Cl. 297/195.1

(57) ABSTRACT

A bike seat adjustment includes a curved locking plate disposed in a joint with both ends of the plate formed a lug and each lug containing an eyelet to receive a first bolt; a coupling block being disposed with a through hole for the first bolt to stick out of the block; an adjusting piece being locked to each first bolt thus to interlock the joint and the coupling block; two levers being locked in place by two locking blocks from the coupling block and a second bolt to allow the second bolt penetrate through a locking block at one end of the coupling block to be secured by another locking block at the other end of the coupling block to lock both levers to a seat tube; and seat angle and lateral position being adjusted respectively by releasing the first and the second bolts.

### BACKGROUND OF THE INVENTION

(a) Field of the Invention

The present invention is related to a bike seat adjustment, and more particularly, to one allows reliable adjustment of elevation angle and lateral position of the seat.

(b) Description of the Prior Art

Referring to FIGS. 1 and 2 of the accompanying drawings showing a bike seat provided with angle and lateral position adjustment function and the coupling between the seat of the bike and its frame, the seat (not illustrated) is provided at its bottom two or more than two levers 10; a coupling block 20 is disposed to where both levers 10 are provided; a seat tube 30 extending upward from a frame (not illustrated) of the bike; a joint 40 connected to the coupling block 20 is disposed at the top of the seat tube 30; and the coupling block 20 is interlocked with the joint 40 by means of a first bolt 50 to secure the seat to the seat tube 30.

An upper clamp 21 and a lower clamp 22 of the coupling block 20 hold onto both levers 10. A through hole 23 is each disposed on the upper and the lower clamps 21, 22 while a locking hole 41 is disposed on the joint 40 to permit penetration by the first bolt 50. A screw 24 is disposed over the upper clamp 20 to engage with the first bolt 50 so that when both of the first bolt 50 and the screw 24 are tightened up, both of the upper and the lower clamps 21, 22 hold fast both levers 10, and both of the coupling block 20 and the joint 40 to firmly secure the seat to the top of the seat tube 30.

Furthermore, where the joint 40 and the coupling block 20 meets is made with a mild curvature, and both planes of the joint 40 and the coupling block 20 that meet each other are respectively provided with serrations 60 to facilitate changing the relative engagement positions of the coupling block 20 and the joint 40 in the adjustment of the angle of the seat.

However, if only the adjustment of the angel of the seat is desired, the lateral position of the seat will be changed at the same time since by releasing the levers 10 from the clamp by the coupling block 20, both levers 10 and the coupling block 20 are loosened up to change the lateral position of the seat. Similarly, if only the adjustment of the lateral position of the seat is desired, the angle of the seat is also changed since releasing the coupling block 20 and the joint 40 form each other also loosens up both of the coupling block 20 and the joint 40 to change the angle of the seat.

### SUMMARY OF THE INVENTION

The primary purpose of the present invention is to provide a bike seat adjustment that permits independent adjustment of seat angle or seat lateral position with affecting the other. To achieve the purpose, the present invention includes a curved locking plate with its both ends each formed with a lug; each lug is disposed with a through hole to admit insertion of a first bolt; and a coupling block is provided with a through hole to admit penetration by the first bolt. By fastening an adjustment piece to each bolt, the coupling block is forced to compress against the joint and the angle adjustment for the seat is achieved by adjusting the position of the coupling block on the locking plates. Two locking blocks and a second bolt are provided for the coupling block to hold two levers in position. The second bolt is inserted into the locking block at one end of the coupling block and then secured with another locking block on the other end of the coupling block to secure both levers on a seat tube of the bike thus to adjust the lateral position of the seat by releasing the second bolt.

While releasing the first bolt to adjust the angle of the seat, both of the coupling block and both levers maintain firm clamping without changing the lateral position of the seat; in turn, upon releasing the second bolt to adjust the lateral position of the seat in relation to the frame, the angle of the seat remains tight.

### BRIEF DESCRIPTION OF THE DRAWINGS

FIG. 1 is a perspective view of the prior art.

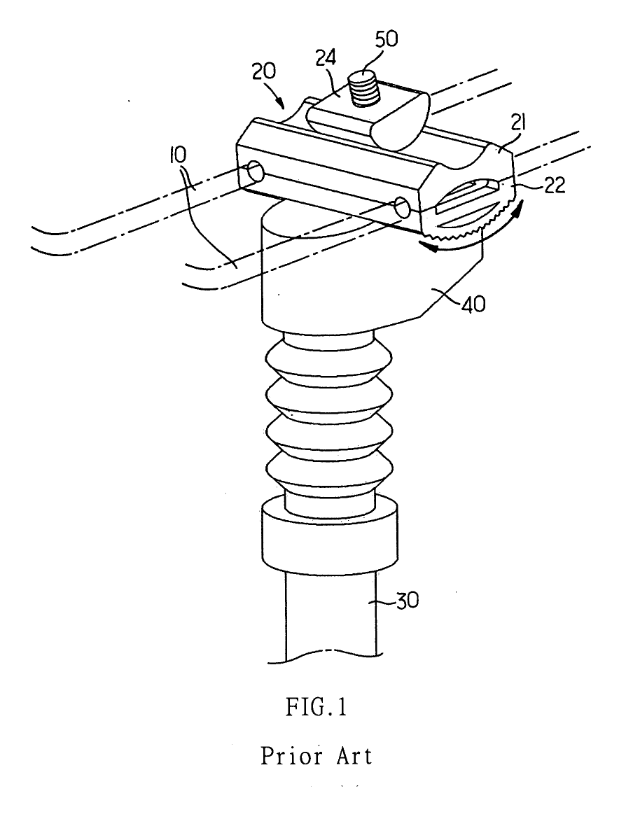

FIG. 2 is a sectional view of the prior art.

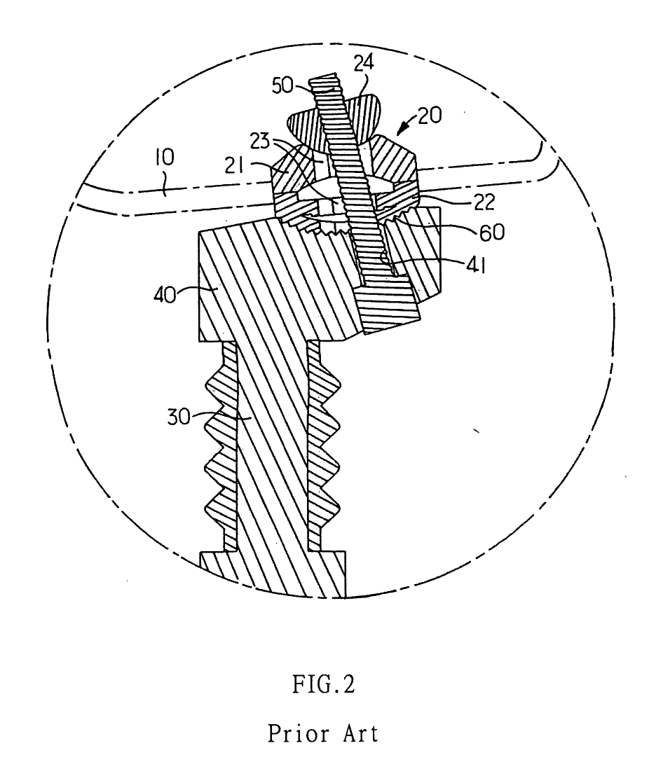

FIG. 3 is a perspective view of a preferred embodiment of the present invention.

FIG. 4 is an exploded view of the preferred embodiment of the present invention.

FIG. 5 is a sectional view of the preferred embodiment of the present invention.

FIG. 6 is another section view of the preferred embodiment of the present invention.

FIG. 7 is an exploded view of another preferred embodiment of the present invention.

FIG. 8 is a schematic view showing adjustment of the present invention.

### DETAILED DESCRIPTION OF THE PREFERRED EMBODIMENTS

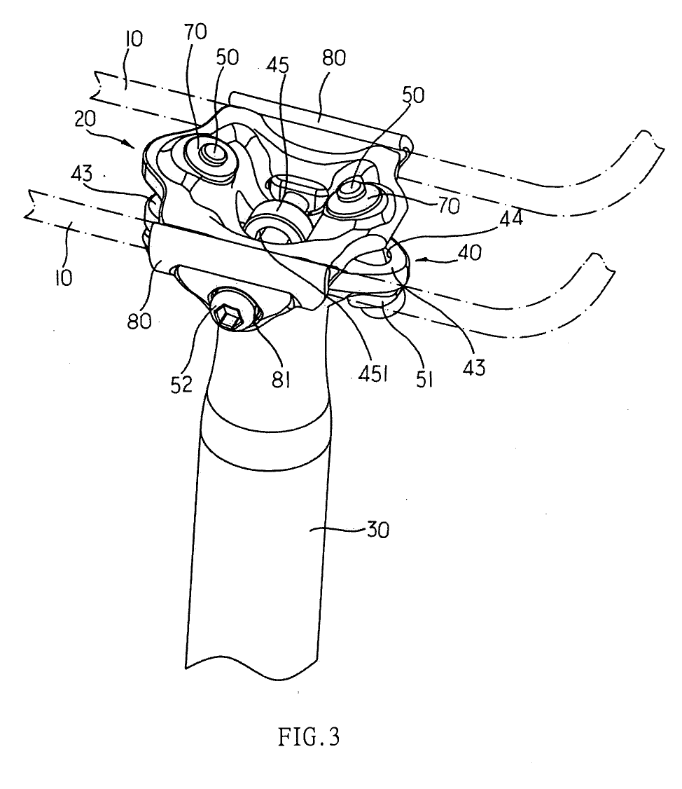

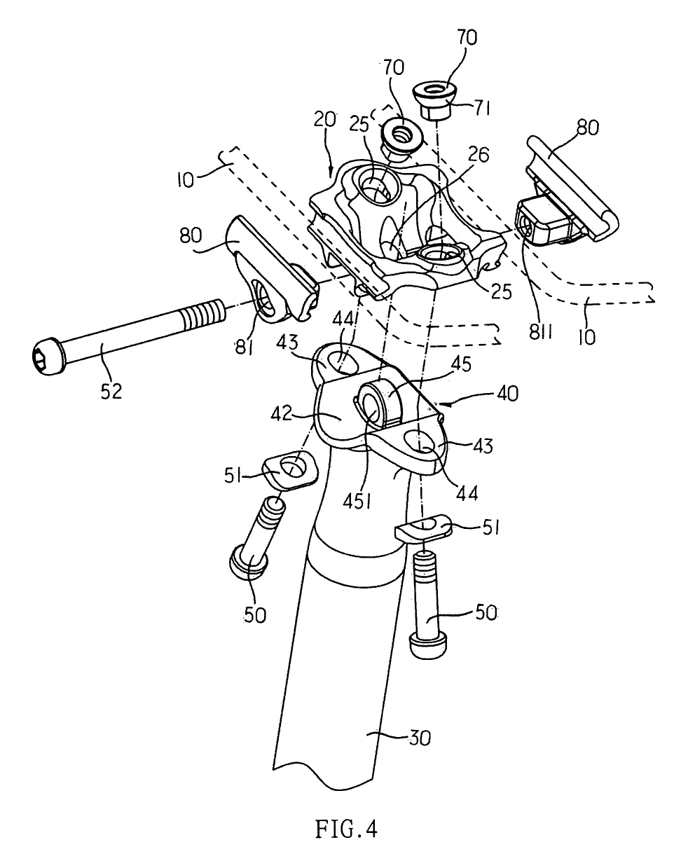

Referring to FIGS. 3 and 4 for a preferred embodiment of the present invention, a bike seat adjustment is essentially comprised of a seat (not illustrated) having at its bottom disposed with two or more than two levers 10 arranged in parallel to each other; a coupling block 20 is disposed to where both levers 10 are provided; a seat tube 30 extends upward from a frame (not illustrated) of the bike; a joint 40 connected to the coupling block 20 is disposed on the top of the seat tube 30; and two first bolts 50 are provided for both of the coupling block 20 and the joint 40 to interlock to each other for securing the seat to the seat tube 30.

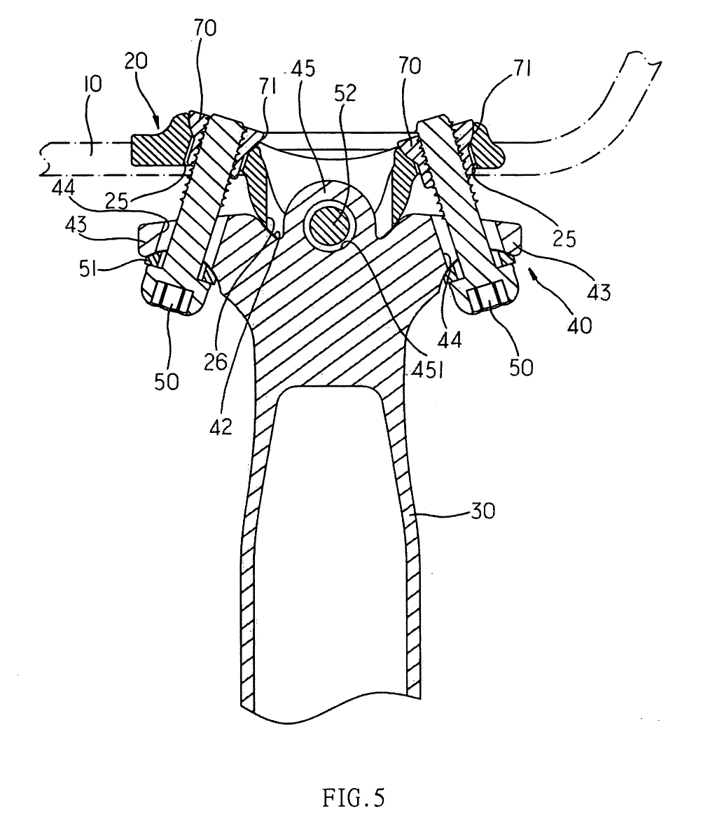

As illustrated in FIG. 5, a curved locking plate 42 is provided to the joint 40, and both ends of the locking plate 42 are respectively disposed with a lug 43. An eyelet 44 is disposed to each lug 43 to receive insertion by the first bolt. One or a plurality of washer 51 is packed between the first bolt 50 and the joint 40. Two through holes 25 are provided to the coupling block 20 to receive insertion by each first bolt 50. The coupling block 20 is interlocked with each first bolt 50 by means of an adjusting piece 70. The binding surface where the adjusting piece 70 meets the through hole 25 is made into an arc plane 71 to interlock the joint 40 and the coupling block 20.

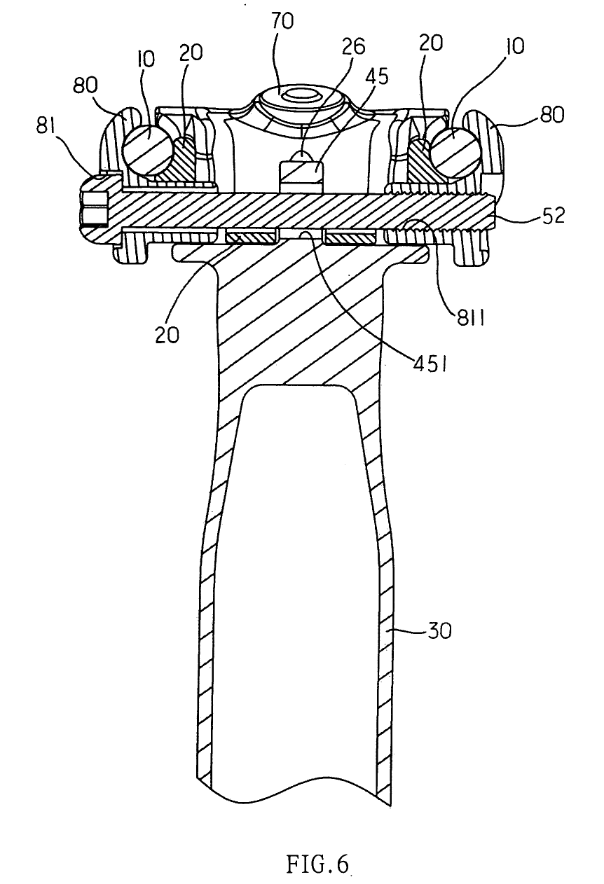

Now referring to FIG. 6, an arc piece 45 having a through hole 451 is disposed on the curved surface of the locking plate 42, and a slot 26 to allow the arc piece 45 to stick out is provided on where both of the coupling block 20 and the locking plate 42 are bound to each other. The diameter of the slot 26 is slightly greater than that of the arc piece 45 to allow the arc piece 45 to move around in the slot 26.

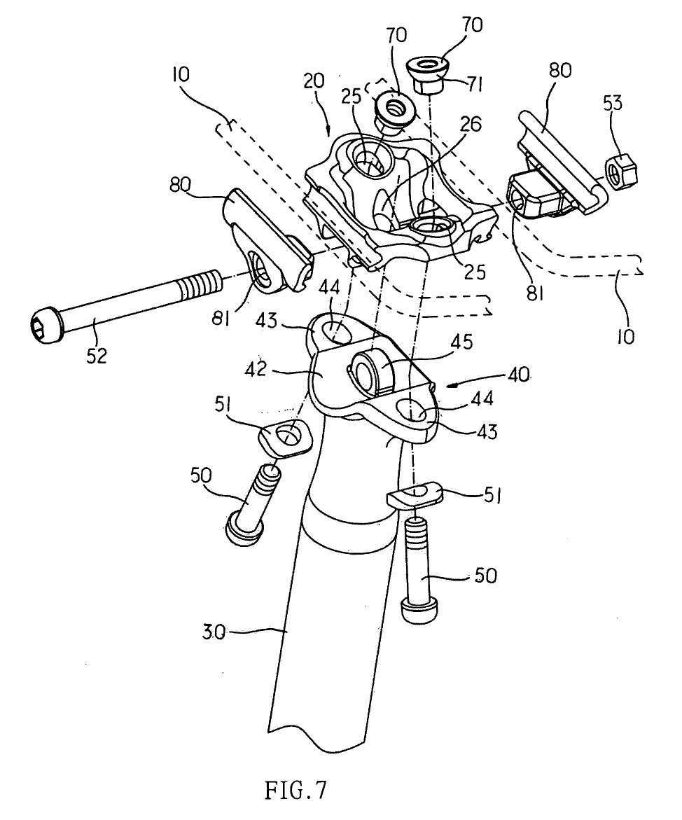

The coupling block 20 holds both levers 10 in position by means of two locking blocks 80 and a second bolt 52. A through hole 81 is disposed on each locking block 80 to permit insertion by the second bolt. The second bolt 52 enters first into the through hole 81 of the locking block 80 at one end of the coupling block 20, and the through hole 451 of the arc piece 45 before being locked in the through hole 81 of another locking block 80 at the other end of the coupling block 20. As illustrated in FIGS. 4, 5, and 6, multiple teeth 811 to mesh the second bolt 52 are provided in the through hole 81 of the locking block 80 for the second bolt 52 to secure both levers 10 onto the seat tube 30. Alternatively, a nut 53 to engage the second bolt 52 is externally provided to the through hole 81 as illustrated in FIG. 7.

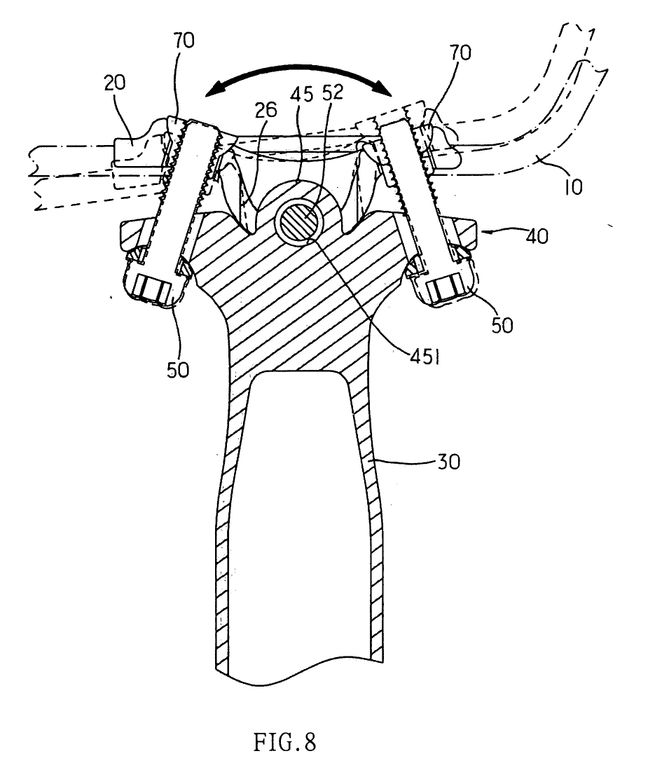

The angle of the seat is adjusted by releasing the first bolt 50 disposed at the lug 43 as illustrated in FIG. 8; and the lateral position of the seat is adjusted by releasing the second bolt 52 disposed at the locking block 80. Upon releasing the first bolt 50 at the lug 43 to adjust the angle of the seat, both levers 10 and both locking blocks 80 remain unaffected without changing the lateral position of the seat. On the contrary, upon releasing the second bolt 52 at the locking block 80 to adjust the lateral position of the seat as illustrated in FIG. 3, the angle of the seat remains unaffected. Accordingly, the present invention allows independent adjustment of the angle or the lateral position of the seat.

The prevent invention provides an improved structure of a bike seat adjustment, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. A bike seat adjustment includes two or more than two levers arranged in parallel to each other at the bottom of the seat; a coupling block being disposed to both levers; a seat tube extending upward from a frame of the bike; a joint connected to the coupling block being disposed at the top of the seat tube; the coupling block and the joint being interlocked to each other by means of two first bolts to secure the seat to the seat tube; the joint related to a curved locking plate; each of both ends of the locking plate being provided with a lug, each lug containing a through hole to receive insertion of the first bolt; a through hole being provided to the coupling block to permit the bolt to stick out; the coupling block being interlocked with each bolt by means of an adjusting piece; both of the joint and the coupling block being interlocked to each other; the coupling block holding both levers in position by means of two locking blocks and a second bolt; and the second bolt entering into the locking block disposed at one end of the coupling block before being secured by another locking block at the other end of the coupling block to secure both levers onto the seat tube.

2. The bike seat adjustment of claim 1, wherein an arc piece containing a through hole is disposed on the curved arc of the locking plate; and a slot to allow the arc piece to stick out is disposed on where both of the coupling block and the locking plate are bound to each other.

3. The bike seat adjustment of claim 2, wherein the slot is slightly greater than the arc piece.

4. The bike seat adjustment of claim 1, wherein each locking is disposed with a through hole to receive insertion by the second bolt; and the through hole of the locking block on that side is disposed with multiple teeth nut to mesh the second bolt.

5. The bike seat adjustment of claim 1, wherein each locking block is disposed with a through hole to receive insertion by the second bolt; and the through hole of the locking block on that side is externally disposed with a nut to mesh the second bolt.

6. The bike seat adjustment of claim 1, wherein on or multiple washer is packed between the first bolt and the joint.

7. The bike seat adjustment of claim 1, wherein the plane where the adjusting piece and the through hole meet is referred to an arc plane.
